(19) United States
(12) Patent Application Publication
(10) Pub. No.: US 2021/0139807 A1
(43) Pub. Date: May 13, 2021

(54) LIQUID ANTIOXIDANT COMPOSITION

(71) Applicant: VANDERBILT CHEMICALS, LLC, Norwalk, CT (US)

(72) Inventors: Martin PAISNER, Norwalk, CT (US); Shubhada DANTALE, Norwalk, CT (US); Vincent J. GATTO, Brandenton, FL (US)

(73) Assignee: VANDERBILT CHEMICALS, LLC, Norwalk, CT (US)

(21) Appl. No.: 17/093,981

(22) Filed: Nov. 10, 2020

Related U.S. Application Data
(60) Provisional application No. 62/933,698, filed on Nov. 11, 2019.

(51) Int. Cl. C10M 141/06; C11C 5/00

(52) U.S. Cl. CPC C10M 141/06; C11C 5/002; C10N 2030/10; C10M 2215/223; C10M 2207/284

(57) ABSTRACT

This invention relates to a liquid antioxidant composition which finds utility as an antioxidant additive in candle wax and lubricant compositions, and has an additional effect of preventing crystallization of the tolutriazole additive used in such compositions. In particular, the antioxidant composition is a combination of an alkylated diphenylamine derivative of tolutriazole with benzyl benzoate.

### BACKGROUND OF THE INVENTION

This invention relates to a liquid antioxidant composition which finds utility as an antioxidant additive in candle wax and lubricant compositions, and has an additional effect of preventing crystallization of the tolutriazole additive used in such compositions. In particular, the antioxidant composition is a combination of an alkylated diphenylamine derivative of tolutriazole with benzyl benzoate.

Vanlube® 887E is a commercial antioxidant used in lubricants (available from Vanderbilt Chemicals, LLD of Norwalk, Conn.). VANLUBE® 887E is 50% 1-[di(4-octylphenyl)aminomethyl]tolutriazole diluted in 50% pentaerythritol based synthetic ester. The product is known to be impacted by crystal fall-out after standing for prolonged periods. Therefore, it is an object of the present invention to find a solution to the crystallization issue, while also providing an additive that shows equivalent or better antioxidant properties.

### SUMMARY OF THE INVENTION

The invention lies in a combination of (1) an alkylated diphenylamine derivative of tolutriazole and (2) benzyl benzoate, wherein the benzyl benzoate is present at 50% or more by weight of the total combination, up to about 80%; preferably at 50% to about 70%; more preferably at about 58% to about 63%; and most preferably at about 61%. Such a combination has utility on its own, in that the presence of benzyl benzoate acts to prevent unwanted crystallization of alkylated diphenylamine derivative of tolutriazole, particularly 1-[di(4-octylphenyl)aminomethyl]tolutriazole, and therefore prolongs the shelf life of this component, which is on its own an effective antioxidant. The tolutriazole derivative may be chosen from one or more in combination of 1-[di(4-octylphenyl)aminomethyl]tolutriazole; 1-[(4-octylphenyl)(phenyl)aminomethyl]tolutriazole; 1-[(4-butylphenyl)(4-octylphenyl)aminomethyl]tolutriazole; 1-[di(4-butylphenyl)aminomethyl]tolutriazole; and 1-[(4-butylphenyl)(phenyl)aminomethyl]tolutriazole. The combination may be an additive mixture of the two components, but is preferably formed as a reaction product of an alkylated diphenyl amine, tolutriazole (and paraformaldehyde) and benzyl benzoate.

The invention lies further in a lubricant composition in which the inventive additive combination of (1) an alkylated diphenylamine derivative of tolutriazole and (2) benzyl benzoate, is present in a base oil in an amount which provides the alkylated diphenylamine derivative of tolutriazole at about 0.010 to about 2.0 percent by weight of the total lubricant composition, preferably about 0.020 to about 0.15 percent by weight, and more preferably about 0.025 to about 0.10 percent by weight.

The invention lies still further in a candle wax composition in which the inventive additive combination (1) an alkylated diphenylamine derivative of tolutriazole and (2) benzyl benzoate is present in a candle wax base in an amount which provides the alkylated diphenylamine derivative of tolutriazole at about 0.01 pph to about 1.0 pph compared to 100 parts paraffin wax; preferably about 0.025 pph to about 0.75 pph; and more preferably about 0.05 pph.

### BRIEF DESCRIPTION OF THE DRAWINGS

FIG. 1 is a bar graph showing comparative oxidation test results, wherein each four-bar grouping shows Vanlube® 887E as the first two bars, and SWD 689-31 as the second two bars, representing two runs at each treat rate. “Active treat rate” refers to the weight percent of the tolutriazole derivative in a Group II base oil, whereas “total treat rate” refers to the weight percent of the tolutriazole derivative in a diluent being either pentaerythritol based synthetic ester (887E) or benzyl benzoate (invention).

FIGS. 2-4 show color change delta E for various samples.

### DETAILED DESCRIPTION OF THE INVENTION

### Experiment SWD 646-255: Preparation of 1-[di(4-octylphenyl)aminomethyl]tolutriazole in 50% benzyl benzoate

In a 500 mL three-necked round bottom flask equipped with a temperature probe, overhead stirrer and Dean Stark set up were charged VANLUBE® 81 (dioctyl diphenylamine) (100 g, 0.254 mole), tolutriazole (33.82 g, 0.254 mole), paraformaldehyde (8.29 g, 0.254 mole) and benzyl benzoate (141.45 g). The mixture was heated under nitrogen to 105-110° C. with rapid mixing. Mixing was continued at 110° C. for five hours. After five hours, water aspirator vacuum was applied and the reaction temperature was raised to 120° C. The reaction mixture was held at this temperature for two hours, followed by nitrogen sweep at 120° C. for two hours. The reaction mixture was allowed to cool to 90° C. under nitrogen, and transferred to a container. A clear dark amber liquid (283.12 g) was isolated.

### Experiment SWD 646-263: Preparation of 1-[di(4-octylphenyl)aminomethyl]tolutriazole in 50% benzyl benzoate

In a 1000 mL three-necked round bottom flask equipped with a temperature probe, overhead stirrer and Dean Stark set up were charged VANLUBE® 81 (dioctyl diphenylamine) (250 g, 0.635 mole), tolutriazole (84.55 g, 0.635 mole), paraformaldehyde (20.72 g, 0.635 mole) and benzyl benzoate (353.63 g). The mixture was heated under nitrogen to 110-115° C. with rapid mixing. Mixing was continued at 115° C. for five hours. After five hours, water aspirator vacuum was applied, and the reaction temperature was raised to 125° C. The reaction mixture was held at this temperature for four hours, followed by nitrogen sweep at 125° C. for three hours. The expected amount of water was recovered, suggesting a complete reaction occurred. The reaction mixture was allowed to cool to 90° C. under nitrogen and transferred to a container. A clear dark amber liquid (679.85 g) was isolated.

### Experiment SWD 689-31: Preparation of 1-[di(4-octylphenyl)aminomethyl]tolutriazole in 61% benzyl benzoate

In a 1 L three-neck round bottom flask equipped with a distillation condenser, overhead stirrer and temperature probe were charged VANLUBE® 81 dioctyldiphenylamine (200 g, 0.508 mol 1 eq.), tolutriazole (67.64 g, 0.508 mol, 1 eq.), paraformaldehyde (16.58 g, 0.508 mol, 1 eq.) and benzyl benzoate (424.34 g). The reaction mixture was heated under nitrogen to 105-110° C. with rapid stirring. Reaction was continued at 110° C. for 3 hours. During this time water was collected as reaction proceeded. Vacuum (30 in. Hg) was applied to completely remove water. Reaction temperature was raised to 125° C. Reaction mixture was held under vacuum at 125° C. for two hours followed by nitrogen sweep for 2 hours. Reaction mixture was cooled to 90° C. under nitrogen and filtered. A clear dark amber liquid (689.75 g) was isolated.

VANLUBE® 887E antioxidant additive is 50% 1-[di(4-octylphenyl)aminomethyl]tolutriazole in 50% pentaerythritol based synthetic ester and shows significant crystal fall out after standing for prolonged periods. Over eight weeks, room temperature stability was studied in connection with (A) 50% 1-[di(4-octylphenyl)aminomethyl]tolutriazole in 50% benzyl benzoate and (B) 39% 1-[di(4-octylphenyl)aminomethyl]tolutriazole in 61% benzyl benzoate. The results indicate that the material (A) having 50% benzyl benzoate showed only minor, but acceptable, amount of fall out; whereas sample (B) having 61% benzyl benzoate and 39% active tolutriazole derivative remains as a clear liquid showing no signs of separation or crystal fall out.

FIG. 1 shows the results of the Rotating Pressure Vessel Oxidation Test (RPVOT) ASTM D2272 of a comparison of VANLUBE® 887E (50% active tolutriazole derivative in diluent oil) and SWD 689-31 (39% active tolutriazole derivative in diluent benzyl benzoate) in a Group II base oil at an amount of the combination which provides 0.025%, 0.05% and 0.1% active tolutriazole derivative (showing two runs at each level) as part of the total lubricant composition showed comparable or better results for SWD 689-31. This data shows clear utility and synergy of 1-[di(4-octylphenyl)aminomethyl]tolutriazole blend in benzyl benzoate in lubricants as an effective antioxidant, when compared to the tolutriazole in the pentaerythritol based synthetic ester. Thus, the benzyl benzoate acts both as an antioxidant synergist in combination with the tolutriazole derivative, but also acts to reduce or prevent crystallization in the tolutriazole derivative.

The base oils present in the lubricating composition are typically oils used in automotive and industrial applications such as, among others, turbine oils, hydraulic oils, gear oils, crankcase oils and diesel oils. The base oil (or basestock) may comprises at least about 90%, at least about 95%, at least about 98% by weight of the total lubricant composition.

Typical lubricant basestocks that can be used in this invention may include natural base oils, including mineral oils, petroleum oils, paraffinic oils and vegetable oils, as well as oils derived from synthetic sources.

In particular, lubricant basestocks that can be used in this invention may be petroleum-based or synthetic stocks including any fluid that falls into the API basestock classification as Group I, Group II, Group III, Group IV, and Group V. The hydrocarbon base oil may be selected from naphthenic, aromatic, and paraffinic mineral oils.

Suitable synthetic oils may also be selected from, among others, ester-type oils (such as silicate esters, pentaerythritol esters and carboxylic acid esters), esters, diesters, polyol esters, polyalphaolefins, hydrogenated mineral oils, silicones, silanes, polysiloxanes, alkylene polymers, polyglycol ethers, polyols, bio-based lubricants and/or mixtures thereof.

1-[di(4-octylphenyl)aminomethyl]tolutriazole was prepared in benzyl benzoate as a diluent. Benzyl benzoate is used in candle wax formulations as a solvent for fragrance molecules. Experiment SWD 646-255 and SWD 646-263 are reactions where 1-[di(4-octylphenyl)aminomethyl]tolutriazole was prepared in 50% benzyl benzoate as a diluent. The diluent is left in the material at the end of the reaction in order to solubilize and facilitate blending of the product. It is desired from a handling and formulation standpoint to have a completely liquid product that does not separate or crystallize on prolonged standing.

Room temperature stability study of 50% 1-[di(4-octylphenyl)aminomethyl]tolutriazole and 50% benzyl benzoate after 8 weeks storage at room temperature indicates that the material is a clear liquid showing no signs of separation or crystal fall out. For comparison, 50% 1-[di(4-octylphenyl)aminomethyl]tolutriazole and 50% of a pentaerythritol based synthetic ester shows significant separation (together constituting Vanlube® 887E) and crystal fall out after standing for prolonged periods. Also, 50% 1-[di(4-octylphenyl)aminomethyl]tolutriazole and 50% of a process oil (Vanlube® 887) shows significant separation and crystal fall out after standing for prolonged periods.

Analytical data for batches SWD 646-255 and SWD 646-263 is below.

Example
1-[di(4-octylphenyl)aminomethyl]tolutriazole in 50% benzyl benzoate

| Property | VC Specification | | SWD 646-255 | SWD 646-263 |
|---|---|---|---|---|
| Flash Point, ° C., | 125 | min | | 169 |
| (ASTM D 6450) | | | | |
| ppm Formaldehyde | 999 | max | 1156 | 456 |
| % Moisture | 0.15 | max | 0.039 | 0.037 |
| % N | 4.6-5.6 | | 5.2 | 5.3 |
| TAN, mg/g KOH, | 6.5 | max | 1.3 | 2.8 |

Performance of 1-[di(4-octylphenyl)aminomethyl]tolutriazole in 50% benzyl benzoate in candle wax was examined as a replacement for UV531.

The following 1-[di(4-octylphenyl)aminomethyl]tolutriazole samples were evaluated for performance in candle wax. All were 100% 1-[di(4-octylphenyl)aminomethyl]tolutriazole except for the sample 646-255 wherein the tolutriazole is diluted in 50% benzyl benzoate.

| | Reaction | 100% | 100% | 100% | 100% | 100% | 50% |
|---|---|---|---|---|---|---|---|
| | solvent | crystalline | crystalline | crystalline | crystalline | amorphous | benzyl benzoate |
| | Theoretica [symbol] | 646- | 646- | 646- | 646-242 | 646-254 | 646-255 |
| % Nitrogen | 10.4 | 10.1 | 10.6 | 10.7 | 10.6 | 10.4 | 5.2 |
| ppm Formaldehyde | <999 | 146 | 156 | 314 | 1306 | 840 | 1156 |
| DSC endotherm C | | 87.5 | 83.4 | 86.6 | 82.2 | Not observed | Not relevant |
| % Moisture | | | | | | 0.12 | 0.039 |

[symbol]

indicates data missing or illegible when filed

Typical candle wax formulation composition is shown below in the table, with the balance being paraffin wax at 100 parts.

| Component | Quantity | Function | Chemical Ingredient |
|---|---|---|---|
| Songsorb 1000 | 0.05 pph | UVA-1 | Benzotriazole |
| UV531 | 0.05 pph | UVA-2 | Benzophenone |
| S2908 | 0.1 pph | Antioxidant | Hexadecyl-3,5-di-t-butyl-4- |
| | | | hydroxybenzoate |

A typical candle wax formulation has two UV absorbers-to absorb high range UV light, Songsorb 1000, (benzotriazole) and to absorb low range UV light such as UV531 (benzophenone). 1-[di(4-octylphenyl)aminomethyl]tolutriazole was tested as an absorber of low range UV light to replace the UV531. S2908 is antioxidant Hexadecyl-3,5-di-t-butyl-4-hydroxybenzoate. In a typical experiment; master batch of paraffin wax was made using “Alpine mint” combination of pigments, UV absorbers and stabilizers, and fragrances. Samples were weighed exactly and poured in aluminum pans. Colorimeter reading was recorded before and after exposure to 65 hours in a black box to calculate color change data. VL 887E is 50% 1-[di(4-octylphenyl)aminomethyl]tolutriazole in a synthetic pentaerythritol based ester. The resulting data is shown in FIGS. 2-4.

FIG. 2 shows that a substitution of 1-[di(4-octylphenyl)aminomethyl]tolutriazole (in this case a 50% dilution synthetic pentaerythritol based ester) for UV531 as the low UV absorber provides comparable protection against discoloration caused by oxidation. A lower delta E result indicates better protection against discoloration. In all of the data shown in FIGS. 2-4, the low UV absorber is present at 0.5 pph compared to 100 parts paraffin wax. Where, the tolutriazole derivative is present, it is at 0.5 pph active tolutriazole (i.e. does not include any diluent in the pph amount). However, as discussed above, the tolutriazole diluted at 50% pentaerythritol based synthetic ester suffers from separation or crystallization after a prolonged period of storage. Therefore, it is desired to provide a means of conveniently using the tolutriazole to gain the benefit of low UV light absorption in paraffin wax while overcoming the storage issue.

From FIG. 3 it is seen that using undiluted 1-[di(4-octylphenyl)aminomethyl]tolutriazole as a substitute for UV531 does not provide comparable protection against discoloration. It is believed that this may be due to the fact that the absence of a diluent renders the tolutriazole in form which is not easily soluble.

FIG. 4 demonstrates that the inventive combination of 1-[di(4-octylphenyl)aminomethyl]tolutriazole diluted in benzyl benzoate provides antioxidant protection which is not only comparable to UV531, but which exceeds the results. Thus, it is seen that the combination additive exhibits a synergy as a low UV absorber while also protecting against crystallization.

The presence of the additive combination of 1-[di(4-octylphenyl)aminomethyl]tolutriazole and benzyl benzoate may be provided in a candle wax formulation at from about 0.1 pph to 1.0 pph, calculated as pph tolutriazole in 100 parts paraffin wax, preferably 0.25 pph to about 0.75 pph, and more preferably at about 0.5 pph. The additive combination of the tolutriazole and benzyl benzoate is exemplified at 50% benzoate. However, it is expected that different ratios will be effective as demonstrated above with respect to lubricant compositions, wherein the benzyl benzoate is present at 50% or more by weight of the total combination, up to about 80%; preferably at 50% to about 70%; more preferably at about 58% to about 63%; and most preferably at about 61%.

What is claimed is:

1. An antioxidant composition comprising a combination of (a) an alkylated diphenylamine derivative of tolutriazole and (b) benzyl benzoate, wherein the weight ratio (b):(a) is at least 50:50 up to about 80:20.

2. The composition of claim 1, wherein the composition is a reaction product of alkylated diphenylamine, tolutriazole and a formaldehyde source in benzyl benzoate diluent.

3. The composition of claim 1, wherein (a) is 1-[di(4-octylphenyl)aminomethyl]tolutriazole.

4. The composition of claim 1, wherein the weight ratio (b):(a) is at least 50:50 up to about 61:39.

5. The composition of claim 4, wherein (a) is 1-[di(4-octylphenyl)aminomethyl]tolutriazole.

6. A lubricating composition comprising a base oil, and an antioxidant composition comprising a combination of (a) an alkylated diphenylamine derivative of tolutriazole and (b) benzyl benzoate, wherein the weight ratio (b):(a) is at least 50:50 up to about 80:20, wherein the antioxidant composition is present in the lubricating composition at an amount which provides component (a) at about 0.01-to about 0.20% by weight of the total lubricating composition.

7. The lubricating composition of claim 6, wherein component (a) is 1-[di(4-octylphenyl)aminomethyl]tolutriazole.

8. The lubricating composition of claim 6, wherein the weight ratio (b):(a) is at least 50:50 up to about 61:39.

9. The lubricating composition of claim 6, wherein the wherein the antioxidant composition is present in the lubricating composition at an amount which provides component (a) at about 0.025-to about 0.10% by weight of the total lubricating composition.

10. The lubricating composition of claim 6, wherein component (a) is 1-[di(4-octylphenyl)aminomethyl]tolutriazole, the weight ratio (b):(a) is at least 50:50 up to about 61:39, and wherein the antioxidant composition is present in the lubricating composition at an amount which provides component (a) at about 0.025-to about 0.10% by weight of the total lubricating composition.

11. A candle wax composition comprising a paraffin wax, and an antioxidant composition comprising a combination of (a) an alkylated diphenylamine derivative of tolutriazole and (b) benzyl benzoate, wherein the weight ratio (b):(a) is at least 50:50 up to about 80:20, wherein the antioxidant composition is present in the candle wax composition at an amount which provides component (a) at about 0.01 pph to about 0.10 pph compared to 100 parts paraffin wax.

12. The candle wax composition of claim 11, wherein component (a) is 1-[di(4-octylphenyl)aminomethyl]tolutriazole.

13. The candle wax composition of claim 11, wherein the weight ratio (b):(a) is at least 50:50 up to about 61:39.

14. The candle wax composition of claim 11, wherein the antioxidant composition is present in the candle wax composition at an amount which provides component (a) at about 0.025 pph to about 0.75 pph.

15. The candle wax composition of claim 11 wherein component (a) is 1-[di(4-octylphenyl)aminomethyl]tolutriazole, the weight ratio (b):(a) is at least 50:50 up to about 61:39, and wherein the antioxidant composition is present in the candle wax composition at an amount which provides component (a) at about 0.025 pph to about 0.10 pph.

16. The candle wax composition of claim 15, wherein the weight ratio (b):(a) is 50:50 and the antioxidant composition is present in the candle wax composition at an amount which provides component (a) at about 0.05 pph.
